(19) United States
(12) Patent Application Publication
(10) Pub. No.: US 2023/0186899 A1
(43) Pub. Date: Jun. 15, 2023

(54) INCREMENTAL POST-EDITING AND LEARNING IN SPEECH TRANSCRIPTION AND TRANSLATION SERVICES

(71) Applicant: ZOOM VIDEO COMMUNICATIONS, INC., San Jose, CA (US)

(72) Inventors: Alexander Waibel, Sammamish, WA (US); Sebastian Stuker, Karlsruhe (DE)

(21) Appl. No.: 17/923,620

(22) PCT Filed: Apr. 2, 2021
(86) PCT No.: PCT/US2021/025621

§ 371 Date: Nov. 7, 2022

Related U.S. Application Data
(60) Provisional application No. 63/022,025, filed on May 8, 2020.

(51) Int. Cl. G10L 15/06; G10L 15/22; G10L 15/26; G06F 40/166; G06F 40/58

(52) U.S. Cl. CPC G10L 15/063; G10L 15/22; G10L 15/26; G06F 40/166; G06F 40/58; G10L 2015/0635; G10L 2015/0638

(57) ABSTRACT

Computer systems and computer-implemented methods provide for interactive and incremental post-editing of real-time speech transcription and translation. A first component is automatic identification of potentially problematic regions in the output (e.g., transcription or translation) that are either likely to be technically processed badly or risky in terms of their content or expression. A second component is intelligent, efficient interfaces that permit multiple editors to correct system output concurrently, collaboratively, efficiently, and simultaneously, so that corrections can be seamlessly inserted and become part of a running presentation. A third component is incremental learning and adaptation that allows the system to use the human corrective feedback to deliver instantaneous improvement of system behavior down-stream. A fourth component is transfer learning to transfer short-term learning into long term learning if the modifications warrant long-term retention.

### PRIORITY CLAIM

The present application claims priority to U.S. provisional application Ser. No. 63/022,025, filed May 8, 2020, which is incorporated herein by reference.

### BACKGROUND

With the advent of advanced speech recognition and translation systems, automatic transcription, translation, subtitling and interpretation for speeches, videos and telecommunication applications are now receiving considerable attention as they are enabling technologies for improved communication and information access. While the underlying technology continuous to improve driving down error rates, the remaining errors, while small in number, can have significant impact and lead to miscommunication and sometimes embarrassment. In many situations such errors are not permissible and require human vetting, review and correction. Consider, for example, the appearance of vulgar language, the misrecognition and mistranslation of names of important actors, the mention of politically charged concepts and words (e.g., racist, sexist, gender, etc.), where an innocent mistake made by an automatic system can be harmful and destructive. Unfortunately, most deployed voice processing systems today are all or nothing: the technology strives to reach perfection in terms of error rates but can never ensure complete satisfaction nor perfection in terms of human understanding and communication. Methods are needed that support a symbiotic collaborative approach between humans and machines to interpretation, that allows the fast and ergonomic correction of such errors in combination with fast learning from and adaptation to such corrections by the machine.

### SUMMARY

In one general aspect, the present invention is directed at computer systems and computer-implemented methods that provide for interactive and incremental post-editing of real-time and off-line speech transcription and translation systems. The system comprises, in various embodiments, four key components.

A first key component is automatic identification of potentially problematic regions in the output (e.g., transcription or translation) that are either likely to be technically processed badly or risky in terms of their content or expression. These are generally indicated by regions of low confidence in the processed result, regions of high disfluency, occurrence of vulgarities, names and acronyms, topically inconsistent terms, and the generation of politically charged concepts/words. Along with technical confidence measures the system also produces an automatic assessment of risk of publication that measures if content is controversial to direct and prioritize a post-editor's attention.

A second key component is intelligent, efficient interfaces that permit multiple editors to correct system output (e.g., transcription or translation) concurrently, collaboratively, efficiently, and simultaneously, so that corrections can be seamlessly inserted and become part of a running presentation.

A third key component is incremental learning and adaptation that allows a system to use the human corrective feedback to deliver instantaneous improvement of system behavior down-stream.

A fourth key component is transfer learning to transfer short-term learning into long term learning if the modifications warrant long-term retention.

According to various aspects, therefore, the present invention is directed to a human (as opposed to machine, formal or programming) language transcription and/or translation system that comprises a microphone for picking up audible output by a speaker during an audio session by speaker, where the audible output is in a first human language. The transcription and translation system further comprises a speech recognition and translation computer system for transcribing the audible output by the speaker in the first spoken language and for translating the transcription to a second human language. The speech recognition and translation computer system is in communication with the microphone. The speech recognition and translation computer system may comprise: an automatic speech recognition module that converts audio of the audible output picked up by the microphone to text (the transcription) in the first human language; a segmentation, true-casing and punctuation module in the first human language; and a language translation module for translating the text in the first human language to translation text in the second human language. The system also comprises one or more client devices in communication with the speech recognition and translation computer system, where each of the one or more client devices comprises a user interface that, in an editor mode: displays the transcribed and/or translated text in the first and/or second human language as the case may be; and accepts corrective inputs from a user of each of the one or more client device, where the corrective inputs comprise corrections to the transcribed and/or translated text. The speech recognition and translation computer system is for: receiving the corrective inputs from the users of the one or more client devices during the audio session; and updating the speech recognition and/or language translation modules based on the received corrected inputs, such that the speech recognition module and/or language translation module uses the corrective inputs in generating the transcription in the first human language and/or translating the transcribed text to the second human language for a remainder of the audio session. The audio session could be, for example, a live audio event or a playback of a recorded audio event (e.g., a speech, presentation, dialog, etc. by one or more speakers).

These and other benefits that are realizable through various embodiments of the present invention will be apparent from the description that follows.

### DRAWINGS

Various embodiments of the present invention are described by way of example in conjunction with the following figures.

FIG. 1A depicts a mobile device in pocket of a user while recording an event.

FIG. 1B depicts an interface for a mobile client according to various embodiments of the present invention while recording a live event.

FIG. 1C depicts a QR Code and sharable link for sharing access to a live event for recording according to various embodiments of the present invention.

FIG. 2A depicts a recording client mobile app interface with an “Off-the-Record” Mute Button according to various embodiments of the present invention.

FIG. 2B depicts a post-hoc control interface for a recording client mobile app according to various embodiments of the present invention.

FIGS. 3A and 3B depict an example of a running, electronic document edited instantaneously by several distributed individuals according to various embodiments of the present invention.

FIGS. 4 and 7 depict an example of a real-time, web-based user interface for a translation editor according to various embodiments of the present invention.

FIG. 5 is a diagram of a computer system according to various embodiments of the present invention.

FIG. 6 is a diagram of an incremental post-editing transcription and translation system according to various embodiments of the present invention.

### DESCRIPTION

In our world the only constant is change, and language reflects this perpetual change: concepts change, vocabularies change, names and acronyms change, new ones appear (who ever heard of “COVID-19” prior to January 2020) and old ones disappear (who ever says “Groovy” anymore?). Human and automatic interpreting alike cannot be a static activity, and an interpreter must continually adapt, learn and grow with the world around us. Viewing interpretation as a living, evolving competence is thus at the heart of this design of a successful automated system. A computer system must be unobtrusive, selective, intelligent and efficient in acquiring and exploiting available data resources without imposing cumbersome new requirements for data preparation, extraction or cleaning.

To realize such a vision, the speech interpretation system of the present invention can continuously learn from a variety of data resources. For example, the system can gather and learn continuously: (i) From text documents in the public domain (news, etc.); (ii) From text documents that pertain directly or are related to the specific speech or lecture in progress (slides, reports, agendas, similar web pages); and last not least, (iii) from individual user correction and user intervention during a lecture, by one or multiple users.

To be effective in practice, learning must also respond to different time periods, granularity and must consider the useful life of information. A new concept or word in the news (e.g., “COVID-19”), for example, may burst on the scene and may be required as a permanent addition to the system, but a name of a speaker or an acronym in one speech alone, may potentially only be of interest during the course of a single lecture (a name or an acronym, for example) and should be forgotten thereafter. Either way, however, the impact of learning must be instantaneous: if a word or concept was noted as important in the beginning of a lecture, it must be available for the rest of the lecture as well (it is genuinely annoying to correct it repetitively, if the learning involves user input).

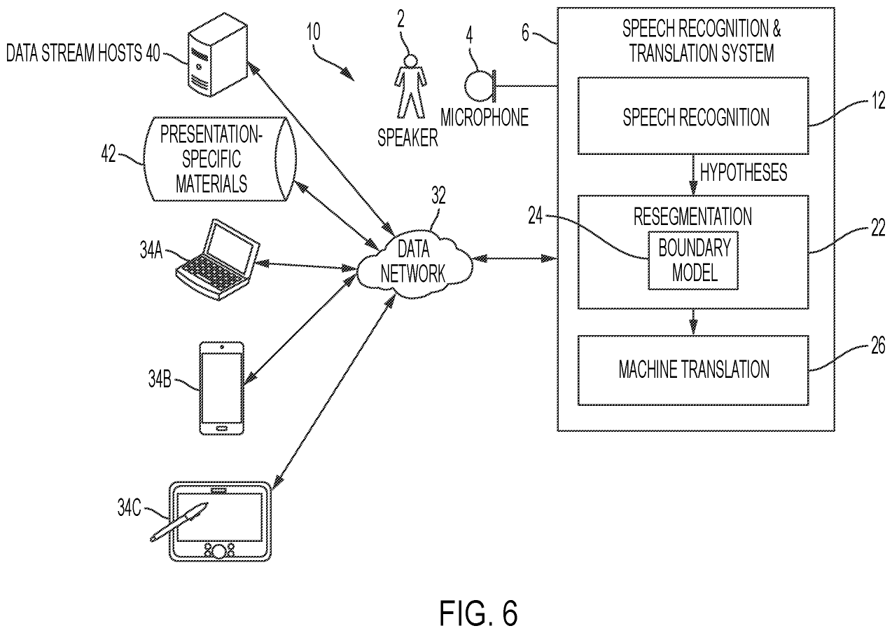

A block diagram of a transcription/translation system 10 is shown in FIG. 6 according to various embodiments of the present invention. Audible speech or output (e.g., lecture, interview, etc.) by a speaker 2 is picked up by a microphone 4. FIG. 6 shows a single speaker 2 for illustrative purposes and it should be recognized that the systems and methods of the present invention could be used for speeches, seminars, presentations, conversations, meetings, etc. by one or multiple speakers. The audible output may be, for example, part of a live or recorded speech, lecture or presentation by the speaker; a live or recorded voice dialog between the speaker and another speaker(s); a recording of the speaker's audible output, such as an audio recording or a multimedia recording (e.g., a video or movie).

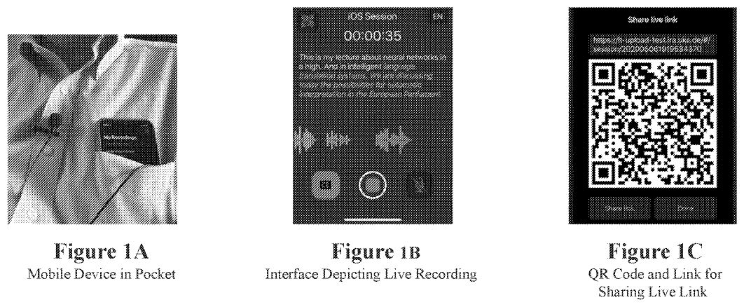

The speech by the speaker 2 is in a first human (as opposed to computer programming) language (e.g., German). The audio picked up by the microphone 4 is input to a computer-implemented speech recognition and translation system 6. The microphone 4 could be, for example, a microphone integrated into a mobile device (e.g., a smartphone, tablet computer, or laptop: see FIGS. 1A-C and 2A-B) or a discrete microphone system in the vicinity of the speaker 2 while the speaker 2 is making a speech/presentation. The microphone 4 may have a wired or wireless connection to the speech recognition and translation system 6, For example, where the microphone 4 is a component of a mobile device, the mobile device may be in communication with the speech recognition and translation system 6 via a wireless communication link such as a WiFi network, a Bluetooth communication link, or a cellular phone network.

A speech recognition unit 12 produces partial hypotheses. The hypotheses are merged, filtered and resegmented by a resegmentation unit 22 using a boundary model 24 to generate a transcription of the speech in the first human language (e.g., the language in which the speaker was speaking). The processed hypotheses (e.g., transcription) are transferred to a machine translation unit 26 for translation into a second human language (e.g., English). In various embodiments, one speech recognition and translation system 6 is used for each language that the speaker's speech is translated into. In other embodiments, the speech recognition and translation system 6 could have multiple translation units 26—one for each human language to which the speaker's speech is to be translated into.

As shown in FIG. 6, the system 10 can comprise a plurality of user devices in communication with the speech recognition and translation system 6 via a data network 32. The user devices are depicted for illustrative purposes in FIG. 6 as mobile devices, such as a laptop computer 34A, a smartphone 34B and a tablet computer 34C. The user devices 34A-C can be used for two purposes. First, in a presentation mode, the transcription and/or translation of the speaker's speech generated by the speech recognition and translation system 6 may be transmitted to and displayed on the mobile devices 34A-C in real-time as the speaker 2 makes the speech. Second, in an editing mode, some of the users of the user devices may be editors of the transcription and/or translation and provide post-editing updates and corrections to the speech recognition and translation system 6 (via the data network 32) so that that the on-going transcription and/or translation of the speaker's speech, prepared by the speech recognition and translation system 6, can incorporate and/or adopt the editors' updates and corrections.

The data network 32 may comprise or include, for example, any suitable computer data network, or combination of computer data networks, such as a LAN, a WAN, the Internet, etc. The data network 32 may comprise wired (e.g., Ethernet) and/or wireless (e.g., WiFi, Bluetooth, cellular) ad hoc or infrastructure networks and/or communication links. User devices other than the mobile devices 34A-C illustratively depicted in FIG. 6 could also be used. For example, a user may use a PC that has a wired network connection to the speech recognition and translation system 6. Also, other types of mobile devices could be used, such as a wearable computer (e.g., a smart watch).

The editing and presentation interfaces provided by the user devices (e.g., the mobile devices 34A-C) could be provided by browser software on the user devices such that the real-time transcription and/or translation and/or the post-editing interfaces are provided by web pages served by the speech recognition and translation system 6 (which may include a web server, not shown, for serving the web pages). The user interface could also be provided on the user devices 34A-C via a dedicated software application installed on and executed by the user device a mobile app on a mobile device 34A-C). In that case, the speech recognition and translation system 6 may comprise an application server (not shown) for serving the transcription and/or translations to the mobile apps. The webpages and/or mobile apps may use HTML5, CSS, TypeScript, JavaScript or web techniques and programming languages.

FIG. 6 also shows, for example, that the speech recognition and translation system 6 can receive data (e.g., text, voice and/or video) from, for example, various Internet data stream hosts 40 (e.g., website servers). The data from the data stream hosts 40 can be used to update the model(s) of the speech recognition system 12; the boundary model 23 of the resegmentation system 22; and/or the model(s) of the machine translation system 26. The data from the data streams 40 can be retrieved by the speech recognition and translation system 6 periodically, e.g., daily, in order to update the models accordingly.

The speech recognition and translation system 6 can also update the models of the speech recognition and translation system 6 based on presentation-specific materials. These materials may be, for example, electronic documents that are stored in a database 42 accessible by the speech recognition and translation system 6 via the data network 32. The electronic documents may comprise, for example, agenda, background reports and/or presentation materials (e.g., slides) relevant to the speech/presentation given by the speaker 2. Preferably, the database 42 is updated with the relevant electronic documents for the presentation prior to the presentation by the speaker 2, so that the models of the speech recognition and translation system 6 can also be updated prior to the presentation by the speaker 2.

The transcription/translation system 10 according to the present invention can include long-term and short-term learning algorithms, as well as effective user-interfaces that link learning systems with the workflow of an institution to instantiate continuous learning while minimizing human attention and requiring little or no technical expertise by the operator. These algorithm can be used for both the transcription and translation systems.

Regarding long term learning, the large volumes of data (text, voice and video) produced today (e.g., the data stream hosts 40) provides a unique opportunity for the speech recognition and translation system 6 to learn and adapt on a daily basis over large streams of data. Such learning includes supervised (if ground truth or transcripts are provided), semi-supervised as well as unsupervised methods, suitable for training, data-augmentation and adaptation. Learning on large evolving data streams can be carried out on a daily basis to inform the speech recognition and translation system 6 of the vocabulary du jour, and of the topics of ongoing discussion. In addition to news sources, the speech recognition and translation system 6 can adapt it models based documents in the database 42, which can include agendas, background reports and presentation materials for adaptation and preparation for the speaker's speech/presentation. Similarly, periodic acoustic training of the models of the speech recognition and translation system 6 can be carried out periodically over large data repositories of transcribed, un-transcribed and partially transcribed data. Continuing adaptation runs permit improvements not only for unusual vocabularies but also to typical accents and noise conditions found in different deployments or venues. Such training runs can be initially be hosted, monitored and accompanied by a R&D team to the models of the systems 12, 22 and 26 for the languages, typical accents, vocabularies and noise environments of the use case. The speech recognition and translation system 6 is then ready for incremental session-by-session learning in the steady state.

Regarding session-by-session incremental learning, for any recording session, temporary, local learning can be applied and informed by humans (operators, staff, or crowd-sourced, depending on the criticality of the event), as well as by locally available data-streams 40 and information resources 42. These uses can use, for example, mobile devices 34A-C to communicate with the speech recognition and translation system 6. This “on-the-fly” incremental learning can operate in several steps.

A first step can be session-based a priori learning. In this first step, locally available information about speakers, topics and suitable background materials pertaining to a planned speech or session, is applied prior to an event, to train, prepare and adapt all system components (e.g., the systems 12, 22, 26) to an anticipated presentation by the speaker 2. For example, names, acronyms, and special terms may already appear in the agenda or in reports (e.g., stored in the database 42) that are ancillary to a scheduled presentation. Modifications can thus already be made to system vocabularies or models prior to the anticipated session or lecture. But not everything can be predicted a priori and remaining errors will need human input and need to be treated for a high-quality product.

A second step can be confidence-based alerts. Remaining errors in the transcription and/or translation can be flagged automatically by low confidence scores or by the occurrence of inconsistent words or expressions during an ongoing lecture. The significance of each of these occurrences can also be flagged so as to better direct attention of a human operator at a user device to segments that really matter (for example a noun or a name will be more significant than an uncertain article). For example, the speech recognition and translation system 6 can be programmed to flag segments of the transcription and/or translation of the speaker's speech where the speech recognition and translation system 6 computes a low confidence score (e.g., below a threshold level) for a particular segment of the transcription or the translation as the case may be. A human expert editor can then make a correction if warranted in either the transcription or the translation, and that correction can be transferred to the system's short-term learning so that on an on-going basis during the remainder of the speaker's speech, presentation, etc., the correct can be made automatically by the speech recognition and translation system 6.

A second category or alerts is aiming at high-risk outputs in the transcription and/or translation that need to be reviewed by humans before publication or broadcasting of the transcription and/or translation. Such high-risk events include vulgar language, insults, sexist, racist language, hate speech, politically or socially charged concepts and words (e.g. “concentration camp”, “rape”, “assault”, etc.), Such concepts require a political vetting to assure that the speaker actually meant to say what he/she said and that an appropriate output interpretation equivalent in nuance, scope and gravity is chosen. Such decisions are best made by professional interpretation experts operating in an editor mode on their user devices for the transcription and/or translation of the presentation, and the high-risk based alerts will enable experts to quickly attend to these difficult decisions and leave the mundane to the speech recognition and translation system 6.

Another step can be human post-editing. Human editors (either assigned on staff or crowd-sourced) operating the user devices (e.g., mobile devices 34A-C) are then introduced to the speech recognition and translation system 6 to correct remaining errors or post-edit risky words/concepts in the transcription and/or translation. Such words cannot be ignored and require human correction. For example, a word like “Remdesivir” (an experimental drug in the COVID-19 pandemic) may appear and may not be captured correctly in an ongoing presentation, but it is quite important that the word is properly transcribed and translated for readability of the output. Human post-editing preferably corrects this error and the corrected text is then immediately inserted and broadcast to all participants. An interface provided by the mobile devices 34A-C according to the present invention allows for such post-editing of the transcription and/or translation. The implementation of the editing interface permits multiple humans to correct errors concurrently, so that the transcription and/or translation can be modified by several staff members and improved collaboratively and asynchronously. Similarly, post-editors may be assigned to monitor and correct multiple sessions concurrently.

Another step can be Short-Term Learning. Once mentioned, a new word (consider the example “Remdesivir”) is quite likely to reappear in the same presentation or session by the speaker 2, and any correction made by a human expert should have immediate effect on the speech recognition and translation system's ongoing speech recognition and translation processing, so that future occurrences in the same session or lecture do not require repeated post-editing. To achieve this, the speech recognition and translation system 6 of the present invention can apply short-term learning, including dynamic modification and/or insertion of words, names, acronyms in the original speech recognition and/or subsequent translation, or adjustments of parameters of the models of the speech recognition and translation system 6. The learning can be both immediate and incremental. For example, after each correction the speech recognition and translation system 6 can updates the behavior of the transcriber (e.g., the automatic speech recognition module) 12 and translator (e.g., machine translation module) 26 moving forward during the rest of the audio session by the speaker. This is to avoid having the speech recognition and translation system 6 make the same mistake over and over again during the transcription and/or translation of the audio session. For example, the speech recognition and translation system 6 can correct a misrecognized or mistranslated word, such as an unusual term like “Remdesivir” (or a names, place, abbreviation, etc.) so that, going forward for the remainder of the audio session, the transcription and/or translation correction can be made for the remainder of the audio session. The speech recognition and translation system 6 can also bias or reinforce this transcription or translation in its models so that the error does not occur in the rest of the lecture/audio session (or at least reduced the likelihood of the error repeating). if the term (e.g., “Remdesivir”) is misrecognized by the transcriber or the translator, an editor can correct it at the first instance and the transcriber or translator, as the case may be, of the speech recognition and translation system 6, with the updated, biased model(s), makes the correction for all instances going forward. Where there error is in the recognizer, the first corrected instance can be re-translated and the correct translation of the corrected term can be used going forward.

This short term/incremental learning is often valuable for names for people, places or things. Names are often transcribed and/or translated erroneously, yet a particular name may be repeated throughout the speech/presentation. It is also valuable for homophones; the wrong homophone could be used in the transcription/translation. If not corrected, the name or homophone will appear incorrectly throughout the transcription/translation. With embodiments of the present invention, once the expert editor enters a correction for the name or homophone early in the speech/presentation, the speech recognition and translation system 6 can adjust its parameter models to make the correction for the remainder of the speech/presentation. It is also valuable for words in the spoken language that have two different meanings, and those two different meanings translate to different words in another language. For example, the English word “nail” can mean a small metal spike (e.g., that is hit by a hammer) or a covering on the tip of one's finger (e.g., a finger nail). The Spanish word for the first type of nail is “clavo” whereas the Spanish word for the second meaning is “uña.” For a speech about hammers and nails, the translation into Spanish should use “clavo” instead of “uña.” If “uña” is used in the raw translation, the expert editor can change it to “clavo” and that incremental change can be transferred to the system's short-term memory so that the remainder of the translation can correctly use “clavo.”

Yet another step can comprise Transfer Learning, e.g., from Short-Term to Long-Term. There is generally no good way of telling whether a new word, (e.g. “Remdesivir”), acronym, accent, or concept should have long term implications and whether it should influence long term learning. An overly hasty retraining of the models of the speech recognition and translation system 6 using such new input can prove counterproductive and even lead to performance degradation or forgetting of lasting and proven long-term knowledge. A long-term learning strategy according to embodiments of the present invention, therefore, retains all such corrections to include them in a balanced manner for long-term training, to affect gradual improvements if the data bears it out.

Far beyond addressing only research questions related to recognition and translation performance, a useful interpretation tool usable in online real-time events must also permit users to engage and operate an interpreting system by themselves without generating distractions or interference at moments of great stress. Such systems must support (and not derail) user focus on the discussion at hand. It must, however, also provide for easy access, control, privacy, and confidence in its accuracy.

To achieve all these conflicting goals, the transcription/translation system 10 can include advanced interface features and submodules that are important for deployment in the field. One of the important considerations in the ubiquitous use of a system for cross-lingual communication in a multilingual environment is to provide for alternate recording environments that use the post-editing techniques of the present invention. Some environments may be well served by semi-permanent installations into the audio system of a conference halls or auditoria, but in many cases a permanent installation is not possible as it is not predictable (external speeches, outside venues, private conference rooms), or not desirable (personal offices, travel, etc.). A system infrastructure according to the present invention, therefore, includes multiple recording clients that operate as an installation in a lecture hall with automatic scheduling functions, or on mobile devices 34A-C for video conferences, or on mobile apps on the mobile devices 34A-C for mobile lecture support. Alternatively, videos, audio records and prerecorded events can also be uploaded to the servers of the speech recognition and translation system 6 via a web client.

The language translation mobile client running, for example, on the mobile devices 34A-C, according to the present invention can be designed with mobility in mind. It can be provided as a mobile app for a smart phone or table computer (or other mobile device) that doubles as a recording app and allows anyone, anywhere, to take advantage of the interpreting capabilities through their own phone (or other mobile device as the case may be). By default, the recording client can be a recording app that makes a backup recording while generating multilingual captioning/interpreting on demand. The output of close captioning and interpreting can be shared with an audience on the spot at the beginning of a session by way of a QR code, or a sharable URL. The app can be activated once in the beginning of an event (interview, speech, etc.). Close captioning can be selected or deselected as desired on the phone (or other mobile device) and the phone can then disappear into one's pocket without requiring further attention. The phone is then worn like a wireless microphone with remote transcription and translation capabilities. FIG. 1A shows an example of a smartphone with the mobile app in a user's pocket. FIG. 1B shows an example of the mobile app interface with recording capabilities; and FIG. 1C shows a QR code that a user could share with another user, and where the QR code encodes a URL to closed captioning and/or translation of a speech being recorded by the mobile app.

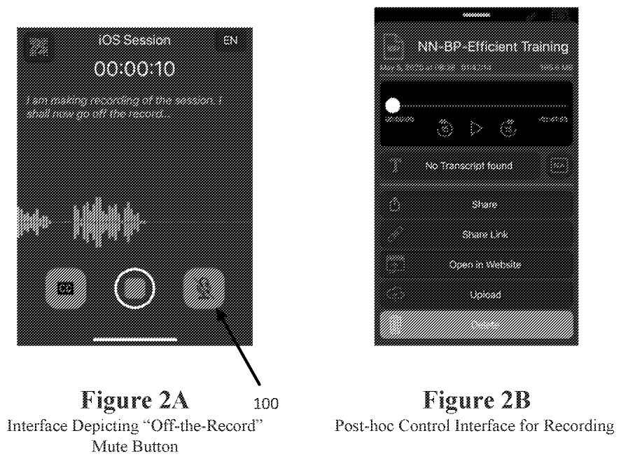

Relating to privacy, all human speech includes informal and formal parts that a user wishes to control during and after a speech or event. Years of experience have sensitized development for this need and the present invention can include simple-to-use privacy control functions, For example, as shown in FIG. 2A, the recording client mobile app can include an “off-the-Record” muting button 100 that is easily applied by a speaker to de/activate recording and transmission of sound and thus allow for control without technical hassles. The mobile app can also provide for control post-hoc (after the event), by allowing the user or his/her staff to post-edit, delete or redact the record prior to release. A record can also be shared, deleted uploaded, published, locally saved, remotely saved, by simple controls from the mobile device, as shown in the example interface shown in FIG. 2B.

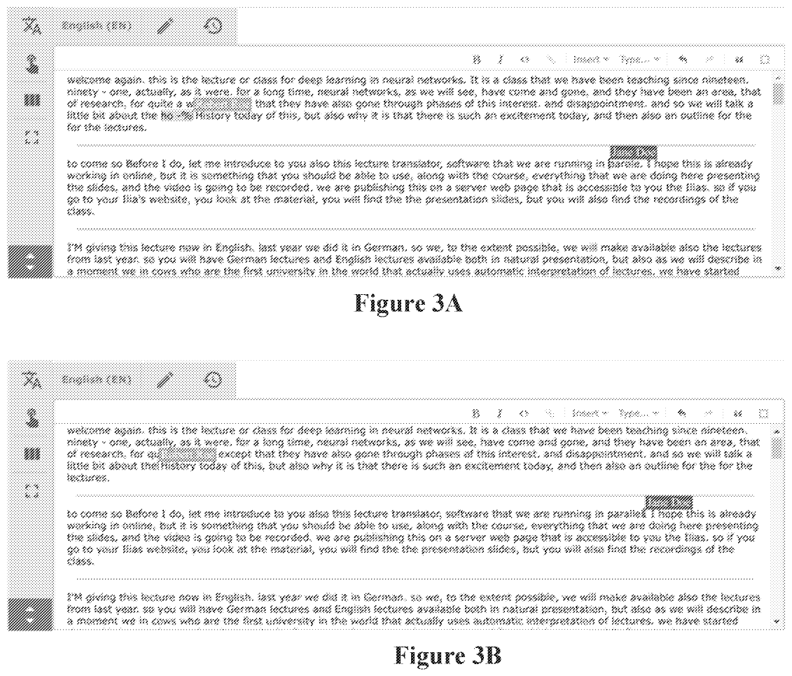

For symbiotic quality control, the transcription/translation system 10 according to embodiments of the present invention can include interface features that make quality control efficient, flexible and easy to use. The transcription/translation system 10 can provide post-editing user interfaces for the mobile devices 34A-C for the recognition (in the original language) or the translation output (for the translated-to language) “on-the-fly” (e.g., during the speech) by multiple asynchronous editors. A running document can thus be edited instantaneously by several distributed individuals and the modifications are immediately visible to all. For example, FIGS. 3A and 38 show examples of the post-editing interface in various embodiments. In FIG. 3A, user “Robert Roe” identified “ho -%” in the transcript as erroneous and user “Jane Doe” identified the word “parole” as erroneous. FIG. 3B shows that user “Robert Roe” on-the-fly edit was to delete “ho -%” in the transcript and user “Jane Doe” changed on-the-fly the word “parole” to “parallel” in the transcript. As shown in the examples of FIGS. 3A-3B, the editing interface can also show by name or user ID which editors made the changes.

All edits can be stored in a stack of modifications, to allow retrieving prior states or versions of the document. Once changes are committed, the edited text can also be immediately sent to the speech recognition and translation system 6 to effect local, immediate learning (e.g. the inclusion of a word or name in the running document, where the long-term importance of the word is not yet known) while retaining it for long term learning in case it remains a growing or important concept of general importance (e.g. “COVID-19”).

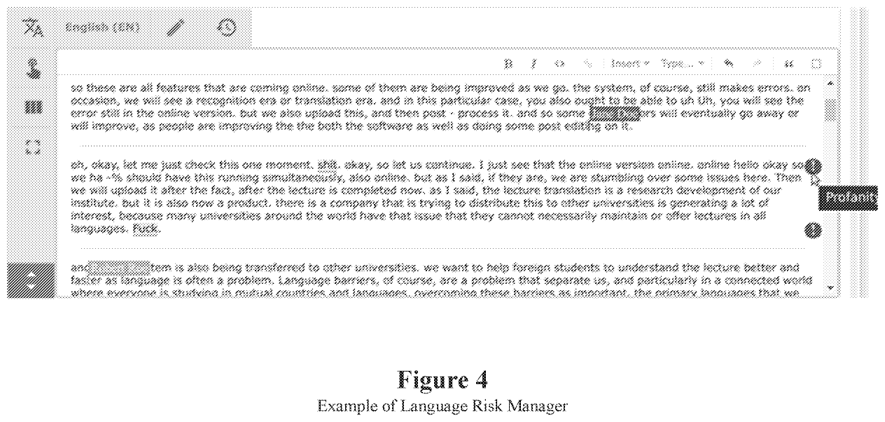

For language risk management, in order to take advantage of the efficiencies gained from automatic recognition and translation, it is impractical for a human operator to always oversee the output from an automatic system, in case intervention is necessary. To alleviate this problem, the speech recognition and translation system 6 can also include Language Risk Management features that process the output text (of either the recognized speech and/or the translation thereof) to determine if human oversight or intervention is warranted. The Language Risk manager of the speech recognition and translation system 6 can generate an alert if one of several risk categories are encountered, including: vulgarities, unusual names, technical terms, politically charged concepts, controversial concepts, hate speech, sexist or racist language, etc. For example, the example interface of FIG. 4 shows how potential profanities in the transcription identified by the language risk manager of the speech recognition and translation system 6 can be flagged in user interface of the mobile device. The language risk manager can flag high risk terms by consulting a database (not shown) of high risk terms as each word in the transcript is generated. If a word in the transcript is in the high risk term database, the language risk manager can flag the words in the transcript, as shown in the example of FIG. 4.

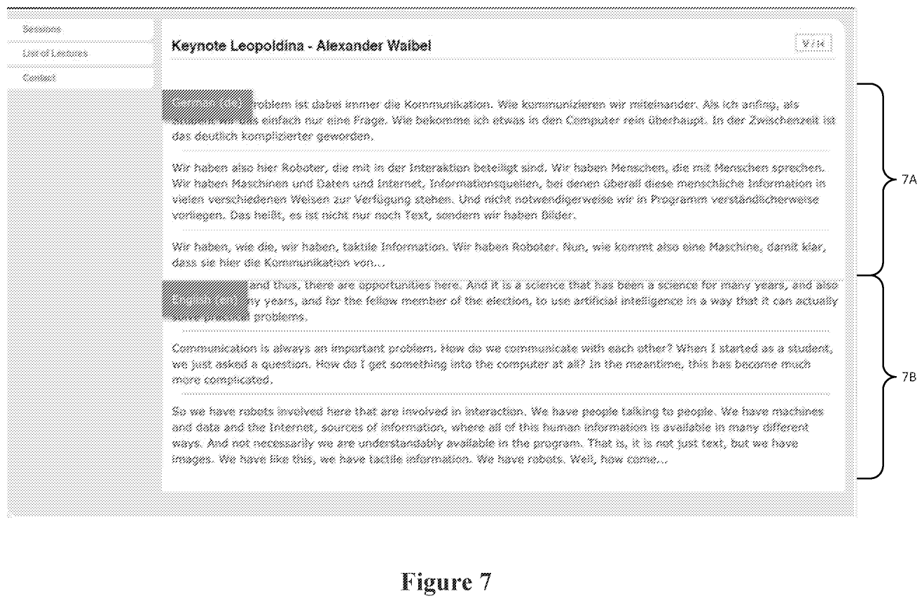

The output from the lecture interpretation steps can be presented in one of several ways: text, speech, or multimedia formats. The most common output in a lecture scenario is to present the transcript of the speech, along with the translation into another language, as shown in example of FIG. 7. In this example, the upper portion 7A of the interface shows the transcription in real-time (as fast as the translation system can generate it) as the speaker is speaking in the language being spoken by the speaker (German in this example). Lower portion 7B shows the translation in real-time (as fast as the translation system can generate it) as the speaker is speaking in the translated-to language (English in this example). The lecture translator interface can also provide a selection menu of output languages. The transcriptions can be displayed in text form on a web page or mobile app that a listener can access on his/her laptop or mobile device. If the lecture is presented online, output can be delivered at low latency, sometimes before a speaker has finished speaking a sentence.

For speech/audible output, the speech recognition and translation system 6 may comprise a text-to-speech module that converts the translated text version of the presentation to audio in the translated-to language. The audio can then be streamed by the speech recognition and translation system 6 to an end-user. For multimedia output, the user interface may show the transcription in text, video of the speaker, and/or the audio in the translated-to language.

Since the transcription may include occasional errors, the speech recognition and translation system 6 can incrementally revise its hypotheses as greater context is obtained. In archival mode, the presenter client can present the video of a lecture aligned with the textual transcript and translation. The currently spoken and translated transcripts are highlighted during playback. Furthermore it is possible to search for keywords and jump to the sections of the recording by clicking on the sought after words in the interface, or by clicking on the presentation slides or images corresponding to the speech.

As mentioned above, the speech recognition and translation system 6 may automatically identify potentially problematic regions in the output for post-editing as described above. The potentially problematic regions can be identified by regions of low confidence in the processed result (e.g., transcription and/or translation), regions of high disfluency, occurrence of vulgarities, names and acronyms, topically inconsistent terms, and the generation of politically charged concepts/words. The speech recognition and translation system 6 may identify vulgarities, names and acronyms, topically inconsistent terms, and politically charged concepts/words through a list (e.g., database or file) of such terms/phrases. Along with technical confidence measures the system also produces an automatic assessment of risk of publication that measures if content is controversial to direct and prioritize a post-editor's attention.

As mentioned above, in real-time as the speech/presentation/etc. is being made, one or more editors may edit the transcription and/or translation to make corrections. One or more editors may edit the transcription in the language in which the speaker is speaking (e.g., German) and one or more editors may edit the translations thereof (e.g., English). There could be one or more editors for each language in which the speech is translated into. To promote the validity and integrity of the corrections, the editors may be vetted beforehand so that trusted editors are used preferably. The pre-vetted editors may have password-protected access to the transcriptions/translations so that they can access the raw transcription/translation for correction prior to publication to the consumers. If editors make different corrections to the same word (or phrase) in the original transcription or any of the translations, the speech recognition and translation system 6 may employ a voting scheme to determine which correction to make.

The speech recognition and translation system 6 can generate the transcription and translations during live or recorded speech sessions (e.g., lectures, presentations, etc.) by the speaker 2. For live sessions, the speech recognition and translation system 6 can make the updates to the transcriptions and/or the translations during the live speech by the speaker, e.g., in real time. For recorded sessions, the speech recognition and translation system 6 can make the updates to the transcriptions and/or the translations during a playing of the recorded speech.

To record a speech by the speaker 2, the system can further comprise recording means for recording the audio picked up by the microphone and an acoustic speaker(s) (e.g., loudspeaker or earphone) for playing the recording of the speech by the speaker 2. To record the speaker's speech, the audio picked up by the microphone can be converted, by a codec, to a digital audio file(s) using an suitable audio file format type, such as WAV, AIFF, FLAC, MPEG-4 SLS or ALS, MP3, etc. The digital audio file can be stored in a suitable data storage device, such as RAM, flash, SSD, magnetic memory, etc. The speech recognition and translation system 6 can then decode and play the recorded audio via the acoustic speaker(s).

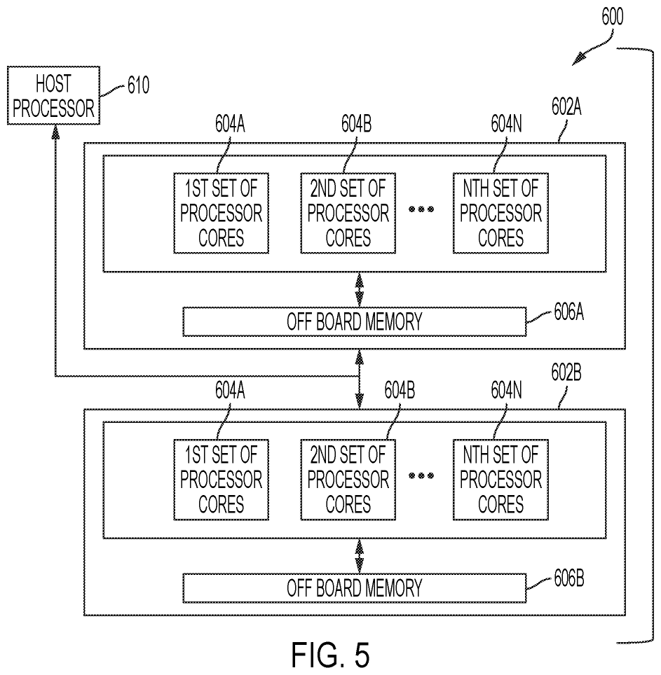

FIG. 5 is a diagram of a computer system 600 that could be used to implement the speech recognition and translation system 6 for example. The illustrated computer system 600 comprises multiple processor units 602A-B that each comprises, in the illustrated embodiment, multiple (N) sets of processor cores 604A-N. Each processor unit 602A-B may comprise on-board memory (ROM or RAM) (not shown) and off-board memory 606A. The on-board memory may comprise primary, volatile and/or non-volatile, storage (e.g., storage directly accessible by the processor cores 604A-N). The off-board memory 606A-B may comprise secondary, non-volatile storage (e.g., storage that is not directly accessible by the processor cores 604A-N), such as ROM, HDDs, SSD, flash, etc. The processor cores 604A-N may be CPU cores, GPU cores and/or AI accelerator cores.

In other embodiments, the computer system 600 could be implemented with one processor unit that is programmed to perform the functions described above. In embodiments where there are multiple processor units, the processor units could be co-located or distributed. For example, the processor units may be interconnected by data networks, such as a LAN, WAN, the Internet, etc., using suitable wired and/or wireless data communication links. Data may be shared between the various processing units using suitable data links, such as data buses (preferably high-speed data buses) or network links (e.g., Ethernet). In addition, the computer system could be in communication with the users' mobile clients through the Internet, WiFi networks, cellular networks, etc.

The software for the speech recognition and translation system 6 may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C #, COBOL, CUDA, Fortran, Java, Lisp, Pascal, Object Pascal, Haskell, ML; and examples of scripting languages include Bourne script, JavaScript, Python, Ruby, Lua, PHP, and Perl.

According to various embodiments, therefore, the present invention is directed to human language transcription and/or translation systems and methods. The human language transcription/translation system can comprise a microphone for picking up audible output by a speaker during an audio session by speaker, where the audible output is in a first human language. The human language transcription/translation system further comprises a speech recognition and translation computer system for transcribing the audible output by the speaker in the first spoken language and for translating the transcription to a second human language. The speech recognition and translation computer system is in communication with the microphone and comprises: an automatic speech recognition module that converts audio of the audible output picked up by the microphone to transcribed text in the first human language; and a language translation module for translating the transcribed text in the first human language to translation text in the second human language. The incremental post-editing transcription and translation system also comprises one or more client devices in communication with the speech recognition and translation computer system. Each of the one or more client devices comprises a user interface that, in an editor mode: displays the transcribed and/or translated text in the second human language; and accepts corrective inputs from a user of each of the one or more client device. The corrective inputs comprise corrections to the transcribed and/or translated text in the second human language. The speech recognition and translation computer system is configured to receiving the corrective inputs from the users of the one or more client devices; and update the speech recognition and/or language translation modules based on the received corrected inputs, such that the speech recognition and/or language translation module uses the corrective inputs in transcribing the text in the first human language or translating the transcribed text into the second human language for a remainder of the audio session.

In another general aspect, the present invention is directed to an incremental post-editing transcription system. The system comprises the microphone for picking up audible output by a speaker during an audio session by speaker. It also comprises a speech recognition computer system in communication with the microphone. The speech recognition system comprises an automatic speech recognition module that converts audio of the audible output picked up by the microphone to transcribed text in the first human language. The system also comprises one or more client devices in communication with the speech recognition computer system. Each of the one or more client devices comprises a user interface that, in an editor mode: displays the transcribed text; and accepts corrective inputs from a user of each of the one or more client device, wherein the corrective inputs comprise corrections to the transcribed text. Also, the speech recognition and translation computer system is for: receiving the corrective inputs from the users of the one or more client devices; and updating the automatic speech recognition module based on the received corrected inputs, such that the automatic speech recognition module uses the corrective inputs in generating the transcribed text for a remainder of the audio session.

In various implementations of the foregoing, the audio session comprises a live audio session by the speaker. In that case, the speech recognition and translation computer system can be configured to generate the transcribed text in the first human language and to translate the transcribed text to the translation text in the second human language during the live audio session. Also, the one or more client devices can be configured to, during the live audio session, display the translated text and accept the corrective inputs; and the speech recognition and translation computer system can be configured to, during the live audio session, receive the corrective inputs and update the language translation module.

In various implementations of the foregoing, the speech recognition and translation module is configured to, after receiving the corrective inputs from the users of the one or more client devices, update the transcribed and/or translated text displayed on the user interface session to include, in a presentation mode, the corrective inputs.

In various implementations of the foregoing, in the presentation mode, the user interface simultaneously displays the text in the first human language and the translated text in the second human language.

In various implementations of the foregoing, the language translation module is configured to, after the audio session, transferring the corrective inputs to a long-term memory for the speech recognition and translation module.

In various implementations of the foregoing, the speech recognition and translation module is configured to, during the audio session: identify a low-confidence word in the translated text in the second human language where the language translation module has a confidence level for the low-confidence word below a threshold confidence level; flag the low-confidence word in the display of the translated text; receive a corrective input from a user of one of the one or more client devices for the low-confidence word; and update a model of the language translation module to use the corrective input for the low-confidence word for the audio session.

In various implementations of the foregoing, the speech recognition and translation module is configured to, during the audio session: identify a high-risk word in the translated text in the second human language; flag the high-risk word in the display of the translated text; receive a corrective input from a user of one of the one or more client devices for the high-risk word; and update a model of the speech recognition and translation module to use the corrective input for the high-risk word for the audio session.

In various implementations of the foregoing, a live speech by the speaker; a live lecture by the speaker; a live presentation by the speaker; an audible voice dialog by the speaker with a second speaker; or a recording of audible output by the speaker. The recording can be a multimedia recording.

In various implementations of the foregoing, in the editor mode, the user interface of the one or more client devices is further configured to: display the transcribed text in the first human language during the audio session; and accept transcribed-text corrective inputs to the displayed transcribed text from the user of each of the one or more client device during the audio session. Also, the speech recognition and translation computer system can be further configured to: receive the transcribed-text corrective inputs from the users of the one or more client devices during the audio session; and update the automatic speech recognition module based on the received transcribed-text corrected inputs during the audio session, such that the automatic speech recognition module uses the transcribed-text corrective inputs in recognizing the audible output by the speaker during the audio session. The speech recognition and translation computer system can be further configured to, upon receiving a transcribed-text corrective input that is applicable to a portion of the transcribed text, re-translate the portion of the transcribed text to the second human language such that the user interfaces of the one or more client devices display the re-translated portion in the second human language.

In various implementations of the foregoing, the human transcription and language translation system further comprises storage means (e.g., a data storage unit) for storing a recording of the audio session and means (e.g., an acoustic speaker) for audibly playing the recording of the audio session. The speech recognition and translation computer system may be configured to generate the transcribed text in the first human language and to translate the transcribed text to the translation text in the second human language during a playing of the recorded audio session. Also, the one or more client devices can be configured to, during the playing of the recorded audio session, display the translated text and accept the corrective inputs. The speech recognition and translation computer system can be configured to, during the playing of the recorded audio session, receive the corrective inputs and update the speech recognition and translation module.

In various implementations of the foregoing, in the editor mode, the user interface of the one or more client devices is further configured to: display the transcribed text in the first human language during the playing of the recorded audio session; and accept transcribed-text corrective inputs to the displayed transcribed text from the user of each of the one or more client device during the playing of the recorded audio session. The speech recognition and translation computer system can be further configured to: receive the transcribed-text corrective inputs from the users of the one or more client devices during the playing of the audio session; update the automatic speech recognition module based on the received transcribed-text corrected inputs during the playing of the recorded audio session, such that the automatic speech recognition module uses the transcribed-text corrective inputs in recognizing the audible output by the speaker during the playing of the recorded audio session; and upon receiving a transcribed-text corrective input that is applicable to a portion of the transcribed text, re-translate the portion of the transcribed text to the second human language such that the user interfaces of the one or more client devices display the re-translated portion in the second human language.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1-31. (canceled)

32. A system comprising:
one or more processors configured to execute processor-executable instructions stored in a non-transitory computer-readable medium, the processor-executable instructions comprising:
an automatic speech recognition module to receive audible output in a first human language during an audio session and convert the audible output to transcribed text in the first human language; and
a language translation module for translating the transcribed text in the first human language to translation text in the second human language;
a correction module in communication with one or more client devices, wherein the correction module:
receives corrective inputs, wherein the corrective inputs comprise corrections to at least one of the transcribed text in the first language or the translated text in the second human language; and
updates at least one of the automatic speech recognition module or the language translation module based on the received corrected inputs, such that the automatic speech recognition module or the language translation module uses the corrective inputs in generating the transcribed text in the first human language or translating the transcribed text to the second human language for a remainder of the audio session.

33. The system of claim 32, wherein the audio session comprises a live audio session.

34. The system of claim 33, further comprising one or more client devices in communication with the one or more processors and configured to, during the live audio session, display the translated text and accept the corrective inputs.

35. The system of claim 34, wherein the language translation module is configured to, after receiving the corrective inputs, update the translated text to include the corrective inputs.

36. The system of claim 35, wherein the one or more client devices are further configured to, during the live audio session, display the text in the first human language and the translated text in the second human language.

37. The system of claim 32, wherein the language translation module is configured to, after the audio session, transfer the corrective inputs to a long term memory for the language translation module.

38. The system of claim 32, wherein the language translation module is configured to, during the audio session:
identify a low-confidence word in the translated text in the second human language where the language translation module has a confidence level for the low-confidence word below a threshold confidence level;
flag the low-confidence word of the translated text;
receive a corrective input for the low-confidence word; and
update a model of the language translation module to use the corrective input for the low-confidence word for the audio session.

39. The system of claim 38, wherein the language translation module is configured to, during the audio session:
identify a high-risk word in the translated text in the second human language;
flag the high-risk word in the display of the translated text;
receive a corrective input for the high-risk word; and
update a model of the language translation module to use the corrective input for the high-risk word for the audio session.

40. The system of claim 32, wherein the audio session comprises an audible voice dialog between the speaker with a second speaker.

41. The system of claim 32, wherein the audio session comprises a recording of audible output by the speaker.

42. The system of claim 32, wherein the recording comprises a multimedia recording.

43. The system of claim 33, wherein the one or more client devices are further configured to:
display the transcribed text in the first human language during the audio session; and
accept transcribed-text corrective inputs to the displayed transcribed during the audio session.

44. The system of claim 43, further configured to, upon receiving a transcribed-text corrective input that is applicable to a portion of the transcribed text, re-translate the portion of the transcribed text to the second human language such that the user interfaces of the one or more client devices display the re-translated portion in the second human language.

45. The system of claim 32, further comprising:
a storage for storing a recording of the audio session; and
an audio output for audibly playing the recording of the audio session; and
wherein the system is configured to generate the transcribed text in the first human language and to translate the transcribed text to the translation text in the second human language during a playing of the recorded audio session;
during the playing of the recorded audio session, cause the translated text to be displayed and accept the corrective inputs; and
during the playing of the recorded audio session, receive the corrective inputs and update the language translation module.

46. The system of claim 45, wherein the system is further configured to:
display the transcribed text in the first human language during the playing of the recorded audio session; and
accept transcribed-text corrective inputs to the displayed transcribed text from the user of each of the one or more client device during the playing of the recorded audio session; and
receive the transcribed-text corrective inputs from one or more client devices during the playing of the audio session;
update the automatic speech recognition module based on the received transcribed-text corrected inputs during the playing of the recorded audio session, such that the automatic speech recognition module uses the transcribed-text corrective inputs in recognizing the audible output by the speaker during the playing of the recorded audio session; and
upon receiving a transcribed-text corrective input that is applicable to a portion of the transcribed text, re-translate the portion of the transcribed text to the second human language such that the user interfaces of the one or more client devices display the re-translated portion in the second human language.

47. A method comprising:
receiving audible output from a speaker in a first human language during an audio session and convert the audible output to transcribed text in the first human language; and
translating the transcribed text in the first human language to translation text in the second human language;
receiving corrective inputs at least one of the one or more client devices, wherein the corrective inputs comprise corrections to at least one of the transcribed text in the first language or the translated text in the second human language and updates at least one of the automatic speech recognition module or the language translation module based on the received corrected inputs,
using the corrective inputs to generate the transcribed text in the first human language or translating the transcribed text to the second human language for a remainder of the audio session.

48. The method of claim 47, wherein:
the audio session comprises a live audio session by the speaker; and
generating the transcribed text in the first human language and to translate the transcribed text to the translation text in the second human language during the live audio session.

49. The method of claim 48, further comprising:
during the live audio session, displaying the translated text and accept the corrective inputs; and
receiving the corrective inputs and update the language translation module.

50. The method of claim 47, further comprising, after receiving the corrective inputs from the users of the one or more client devices, updating the translated text displayed on the user interface session to include, in a presentation mode, the corrective inputs.

51. The method of claim 50, further comprising, simultaneously displaying the text in the first human language and the translated text in the second human language.
